(19) United States
(12) Patent Application Publication
(10) Pub. No.: US 2004/0204040 A1
(43) Pub. Date: Oct. 14, 2004

(54) Residential communication system

(76) Inventor: Antonius Ludovicus Johannes Cornelis Heijnen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 09/840,811

(22) Filed: Apr. 24, 2001

(30) Foreign Application Priority Data
Apr. 26, 2000 (EP) 00201468.6

(51) Int. Cl. H04M 1/00

(52) U.S. Cl. 455/554.2

(57) ABSTRACT

The residential communication system (2) according to the invention comprises a telephone gateway (4), at least one station (6) and a communication network (10) for interconnecting the telephone gateway (4) and the station (6). The telephone gateway (4) receives via the communication network (10) out-going telephone signals from the station (6) and supplies these out-going telephone signals to a non-residential telephone network (12). The residential communication system (2) comprises a further telephone gateway (8), which is connected to the communication network (10). The telephone gateway (4) can transmit part of the out-going telephone signals via the communication network (10) to the further telephone gateway (8), which supplies them to a further non-residential telephone network (14). In this way, least cost routing can be implemented in a in-home network where separate telephone gateways (4,8) are available for connection to separate telephone networks (12,14).

The invention relates to a residential communication system comprising a telephone gateway and at least one station, the telephone gateway and the station being interconnected via a communication network, the telephone gateway being arranged for receiving via the communication network out-going telephone signals from the station and for supplying the out-going telephone signals to a non-residential telephone network.

The invention further relates to a telephone gateway for use in a residential communication system and to a further telephone gateway for use in a residential communication system.

A residential communication system according to the preamble is known from the document “The Home Phoneline Networking Alliance, A White Paper, June 1998” which can be found on the Internet at http://www.homepna.org/docs/wp1.htm. Nowadays, residential communication systems such as in-home (digital) networks receive a lot of attention. By means of these residential communication systems new functionality can be provided, like for instance resource sharing (e.g. remote usage of a digital VCR, a printer, a security camera etc.) and follow me (when a person moves through the house, the music he is listening to follows his/her movement). In the known residential communication system ordinary phonelines are used to interconnect devices or stations, such as a telephone and a set-top box. The known residential communication system comprises a telephone gateway for coupling the residential communication system to a public telephone network, such as a POTS or a PSTN telephone network. Out-going telephone calls originating from the telephone are routed via the phoneline communication network and the telephone gateway to the public telephone network. In-coming telephone calls originating from the public telephone network are routed via the telephone gateway and the phoneline communication network to the telephone.

The known residential communication system is relatively inflexible in that it only interfaces with a single non-residential telephone network.

It is an object of the invention to provide a residential communication system which can interface with several non-residential telephone networks. This object is achieved in the residential communication system according to the invention, which is characterized in that the residential communication system comprises a further telephone gateway, the further telephone gateway being interconnected with the telephone gateway and the station via the communication network, the telephone gateway being arranged for transmitting at least part of the out-going telephone signals via the communication network to the further telephone gateway, the further telephone gateway being arranged for receiving the at least part of the out-going telephone signals via the communication network from the telephone gateway and for supplying the at least part of the out-going telephone signals to a further non-residential telephone network. By means of the further telephone gateway, which may be comprised in a set-top box, the residential communication system interfaces with the further non-residential telephone network, e.g. a CATV-network which offers telephone services. The telephone gateway receives the out-going telephone signals from the station. Some or all of these out-going telephone signals may, e.g. for reasons of cost, best be supplied to the further non-residential telephone network. Therefore this part of the out-going telephone signals is transmitted by the telephone gateway via the communication network to the further telephone gateway, which supplies this part of the out-going telephone signals to the further non-residential telephone network. The remaining part of the out-going telephone signal is supplied by the telephone gateway to the non-residential telephone network.

An embodiment of the residential communication system according to the invention is characterized in that the telephone gateway comprises a least cost router. By this measure the telephone gateway can route out-going telephone signals to the cheapest non-residential telephone network. For instance, in the United States local telephone calls via a regular POTS/PSTN telephone network are normally for free, while non-local telephone calls normally have to be paid for. Other telephone networks, such as CATV-networks, may offer cheaper rates for these non-local telephone calls. In such a case the least cost router in the telephone gateway may route the local out-going telephone signals to the POTS/PSTN telephone network, while the non-local out-going telephone signals may be routed to the further telephone gateway for supply to the CATV-network.

An embodiment of the residential communication system according to the invention is characterized in that the communication network comprises a phoneline network. Phoneline networks, such as used in the HomePNA communication system, offer the advantage that in most cases no or only a few new wires are needed as in most buildings already a substantial phone wire infrastructure is present.

The above object and features of the present invention will be more apparent from the following description of the preferred embodiments with reference to the drawings, wherein:

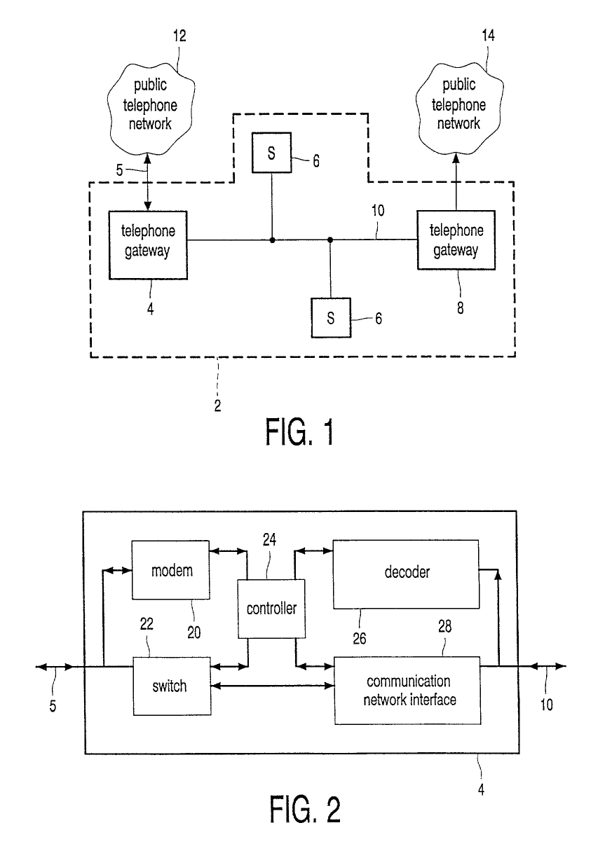

FIG. 1 shows a block diagram of an embodiment of the residential communication system according to the invention,

FIG. 2 shows a block diagram of an embodiment of the telephone gateway according to the invention.

In the Figures, identical parts are provided with the same reference numbers.

FIG. 1 shows a block diagram of an embodiment of a residential communication system 2 according to the invention. The communication system 2 comprises a telephone gateway 4, a further telephone gateway 8 and one or more stations 6. The telephone gateway 4, the further telephone gateway 8 and the stations 6 are interconnected via a communication network 10. Alternatively, the telephone gateway 4 may be comprised in one of the stations 6. Similarly, the further telephone gateway 8 may be comprised in one of the other stations 6. The telephone gateway 4 is coupled via a connection 5 to a public telephone network 12 and the further telephone gateway 8 is coupled to a further public telephone network 14. The communication network 10 may be a phoneline network, i.e. a network that is based upon ordinary phone lines/wires. The communication system 2 may be a HomePNA communication system. The public telephone network 12 may be a POTS or PSTN network. The further telephone network 14 may be a CATV network which offers telephone services. In the latter case the further telephone gateway 8 may be comprised in a set-top box.

One or more of the stations 6 may comprise a telephone. Out-going telephone signals originating from such a telephone are transferred via the communication network 10 to the telephone gateway 4. The telephone gateway 4 either supplies these telephone signals to the public telephone network 12 or transmits via the communication network 10 to the further telephone gateway 8. The further telephone gateway 8 supplies these out-going telephone signals to the further public telephone network 14.

The telephone gateway 4 may comprise a least cost router so that the out-going telephone signals can be routed to one of the public telephone networks 12 or 14 on the basis of the costs of making telephone calls.

FIG. 2 shows a block diagram of an embodiment of the telephone gateway 4 according to the invention. The telephone gateway 4 comprises a switch 22, a communication network interface 28, a decoder 26 and a controller 24. The decoder 24 detects and interprets various direct telephone commands, such as off-hook, on-hook and pulse dialing codes, received from the communication network 10 and sends them to the controller 24. The controller 24, which may be a microprocessor running a dedicated software program, controls the switch 22 and the communication network interface 28. If an out-going telephone signal is received from the communication network 10 it is first decoded in the decoder 26. On basis of the telephone number comprised in the telephone signal the controller 24 may decide whether this out-going telephone signal should be supplied to the public telephone network 12 or to the further public telephone network 14. For instance, if it is a local telephone number the out-going telephone signal may be supplied via the controller 24 and the switch 22 to the public telephone network 12. Alternatively, in case of a non-local telephone number, the outgoing telephone signal may be supplied via the controller 24 and the switch 22 to the communication network interface 28 (e.g. a Home PNA interface comprising bi-directional bus drivers). This communication network interface 28 then converts and transmits the outgoing telephone signal via the communication network 10 to the further telephone gateway 8, which supplies the outgoing telephone signal to the further telephone network 14.

The controller 24 may be programmed by a station 6, e.g. a PC, via the communication network interface 28. Alternatively, the controller 24 can be remotely programmed via the (optional) modem 20.

The scope of the invention is not limited to the embodiments explicitly disclosed. The invention is embodied in each new characteristic and each combination of characteristics. Any reference signs do not limit the scope of the claims. The word “comprising” does not exclude the presence of other elements or steps than those listed in a claim. Use of the word “a” or “an” preceding an element does not exclude the presence of a plurality of such elements.

1. A residential communication system (2) comprising a telephone gateway (4) and at least one station (6), the telephone gateway (4) and the station (6) being interconnected via a communication network (10), the telephone gateway (4) being arranged for receiving via the communication network (10) out-going telephone signals from the station (6) and for supplying the out-going telephone signals to a non-residential telephone network (12), characterized in that the residential communication system (2) comprises a further telephone gateway (8), the further telephone gateway (8) being interconnected with the telephone gateway (4) and the station (6) via the communication network (10), the telephone gateway (4) being arranged for transmitting at least part of the out-going telephone signals via the communication network (10) to the further telephone gateway (8), the further telephone gateway (8) being arranged for receiving the at least part of the out-going telephone signals via the communication network (10) from the telephone gateway (4) and for supplying the at least part of the out-going telephone signals to a further non-residential telephone network (14).

2. A residential communication system (2) according to claim 1, characterized in that the telephone gateway (4) comprises a least cost router.

3. A residential communication system (2) according to claim 1 or 2, characterized in that the communication network (10) comprises a phoneline network.

4. A residential communication system (2) according to claim 3, characterized in that the residential communication system (2) comprises a HomePNA communication system.

5. A residential communication system (2) according to any one of the preceding claims, characterized in that the further telephone gateway (8) is comprised in a set-top box.

6. A residential communication system (2) according to claim 5, characterized in that the further non-residential telephone network (14) is a CATV-network.

7. A telephone gateway (4) for use in a residential communication system (2) comprising at least one station (6), the telephone gateway (4) and the station (6) being interconnected via a communication network (10), the telephone gateway (4) being arranged for receiving via the communication network (10) out-going telephone signals from the station (6) and for supplying the out-going telephone signals to a non-residential telephone network (12), characterized in that the telephone gateway (4) is arranged for transmitting at least part of the out-going telephone signals via the communication network (10) to a further telephone gateway (8).

8. A further telephone gateway (8) for use in a residential communication system (2) comprising a telephone gateway (4) and at least one station (6), the further telephone gateway (8), the telephone gateway (4) and the station (6) being interconnected via a communication network (10), the telephone gateway (4) being arranged for receiving via the communication network (10) out-going telephone signals from the station (6) and for supplying a first part of the out-going telephone signals to a non-residential telephone network (12), the telephone gateway (4) being further arranged for transmitting a second part of the out-going telephone signals via the communication network (10) to the further telephone gateway (8), the further telephone gateway (8) being arranged for receiving the second part of the out-going telephone signals via the communication network (10) from the telephone gateway (4) and for supplying the second part of the out-going telephone signals to a further non-residential telephone network (14).
